(19) United States
(12) Patent Application Publication
(10) Pub. No.: US 2006/0075269 A1
(43) Pub. Date: Apr. 6, 2006

(54) Distributed link-layer wake-up agent system, method, and device for universal plug and play function with low power proxy

(75) Inventors: Yin-Ling Liong, San Diego, CA (US); Yinghua Ye, Stoneham, MA (US); Franklin Reynolds, Bedford, MA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/244,126

(22) Filed: Oct. 5, 2005

Related U.S. Application Data
(60) Provisional application No. 60/616,542, filed on Oct. 6, 2004.

(51) Int. Cl. G06F 1/26

(52) U.S. Cl. 713/300

(57) ABSTRACT

Provided are improved systems, methods, and devices for a distributed network architecture for permitting a low power proxy to wake a power saving device from an offline power saving mode using a wake up agent operating a link layer wake up mechanism. The distributed network architecture using wake up agents allows a power saving device to coordinate a relationship with an access point capable of waking the power saving device from an offline mode, allows the power saving device to communicate that relationship to a proxy entity or other control point, and to permit the proxy entity and other control points to use wake up mechanisms to instruct wake-up capable access points to wake a power saving device from an offline mode, such as to wake a UPnP™ device from a deep sleep offline power saving mode.

### CROSS-REFERENCE TO RELATED APPLICATION

This application claims priority to and the benefit of the filing date of U.S. Patent Application 60/616,542, entitled “Distributed Link-Layer Wake-Up Agent System, Method, and Device for Universal Plug and Play Function with Low Power Proxy,” filed Oct. 6, 2004, the contents of which are incorporated by reference.

### FIELD OF THE INVENTION

The present invention relates generally to universal plug and play (UPnP™) devices and, more particularly, to systems, methods, and devices for operating with UPnP™ power saving devices.

### BACKGROUND

Electronic devices typically now have more power modes or settings than just on and off. Often devices are capable of operating in a “stand-by” mode or similar intermediate power mode designed to consume less power and, possibly, also reduce wear on electronic components of the device. And as mobile devices continue to become increasingly popular, power consumption by those mobile devices continues to be an important subject. In addition to multiple power modes, many electronic devices also have different modes or settings of operation. For example, a computer or like device may operate in an online mode and in an offline mode.

The architecture and functionality of the Universal Plug and Play™ (UPnP™) standard of the UPnP™ Implementers Corp. of San Ramon, Calif., which is an extension of the Device Plug and Play (PnP™) standard from system and hardware to the network and system environment, enables discovery and control of networked devices. For example, the UPnP™ standard can be used with computer equipment such as personal computers and printers, consumer electronic equipment such as televisions and set-top boxes, mobile devices such as mobile phones, laptops, and personal digital assistants, and like electronic devices. The UPnP™ standard can be used, for example, in a digital home environment to discover and control the electronic devices present in the home network(s).

Electronic devices which use power saving modes can cause communication problems in a networked environment, such as UPnP™ interconnected environment. For example, if a mobile phone is placed in a sleep mode, possibly also referred to as a hibernate mode, offline sleep mode, or the like, other devices on the network may no longer be able to identify the presence of and/or communicate with the mobile phone. By way of another example, a set-top box associated with a first television at one location in a user's home can record a program. The user can then watch the recorded program from a second television in the home. If the second television is unable to communicate with the set-top box which recorded the program, the user may need to go to the set-top box to turn the set-top box on or wake the set-top box from a power saving, offline sleep mode which prevents the second television from accessing the program recorded on the set-top box.

UPnP™ power management may provide for several standardized power and/or connection modes, such as active, transparent sleep, deep sleep online, deep sleep offline, and disconnect. UPnP™ devices may be designed to permit only link-layer wake up mechanisms to wake up or activate a device in an offline mode, such as by signaling a device with a link-layer beacon message. Although the device may be offline in terms of network connectivity, such as IP connectivity, the device may be awakened or activated using link-layer signaling. For example, link-layer signaling may be used to awaken a device in deep sleep offline mode or similar power saving mode where network connectivity, other than link-layer connectivity, is unavailable to communicate with the device. By comparison, when a device is in an online power saving mode, an IP-layer mechanism such as an IP message may typically be used to awaken the device from the power saving mode.

A network device or software module referred to as a low power proxy may be used in conjunction with power saving devices. A low power proxy typically is a network device/control point hosting a low power proxy service, acting as an agent of a device for handling UPnP™ functions for the device when the device is in a low power, often offline, setting such as handling UPnP™ control actions. Using low power proxies, other control points can still see the device even when the device may have gone into a sleep mode or offline. However, a low power proxy may not operate on the same network interface as the power saving device, or may only operate on one or a limited number of network interfaces, thereby limiting the number of power saving devices with which the low power proxy could possibly communicate. Further, the low power proxy may not know the mechanics and/or protocols to wake up a power saving device. And the low power proxy may not have the capabilities to communicate with an offline low power device. For example, the low power proxy may have limited link-layer interface capabilities not including the link-layer interface required for a power saving device, the low power proxy may be a hardware device without any link-layer interface capabilities, or the low power proxy may only be a software element.

Accordingly, there is a need in the art for an improved system, method, and devices for permitting a low power proxy to wake a power saving device from an offline power saving mode from different subnets.

### SUMMARY

In light of the foregoing background, embodiments of the present invention provide improved systems, methods, and devices for permitting a low power proxy to wake a power saving device from an offline power saving mode from different subnets, thereby providing network operability of a power saving device when the device is operating in an online mode and permitting the device to operate in a power saving standby mode capable of being woken by a link layer wake up agent. The present invention provides a network architecture that enables an online and possibly wired and/or software-only low power proxy the ability to wake a device from a power saving offline mode using an intermediary wake up agent, such as a wireless access point capable of signaling the power saving device using a link-layer communication interface. The present invention allows a power saving device to coordinate a relationship with an access point or relationships with access points capable of waking the power saving device from an offline mode, allows the power saving device to communicate that(those) relationship(s) to a proxy entity or other control point(s), and to permit these proxy entity(ies) and other control point(s) to use wake up mechanisms to instruct wake-up capable access points to wake a power saving device from an offline mode, such as to wake a UPnP™ device from a deep sleep offline power saving mode.

Embodiments of methods for communicating with a power saving device are provided. Methods may include the steps of identifying a wake up agent capable of signaling the power saving device to wake up from an offline power saving mode and providing information of an association between the power saving device and the wake up agent to a low power proxy. A method may further include the step of placing the power saving device in an offline power saving mode. The step of identifying a wake up agent may include the steps of establishing communication between the power saving device and the wake up agent and communicating the wake up capabilities of the wake up agent to the power saving device.

Embodiments of methods of communicating with a power saving device are also provided which include the steps of receiving a request to wake up the power saving device and signaling the power saving device to wake up, such as waking the power saving device from an offline power saving mode. A method may also include the step of associating the wake up request with signaling the power saving device. The step of receiving a request to wake up the power saving device may include the step of receiving the identity of the power saving device to be awakened. The step of receiving a request to wake up the power saving device may also include the step of receiving security information for waking up the power saving device.

Embodiments of methods of controlling waking up a power saving device are also provided which include the steps of determining offline status of the power saving device, preventing the transmission of network packets for the power saving device, receiving a wake up message for the power saving device, and signaling for the power saving device to wake up. The step of determining offline status may include the step of receiving a going-to-sleep message or the step of performing UPnP™ sniffing. The step of preventing the transmission of network packets may include the step of associating the offline status of the power saving device with discontinuing activity which could wake up the power saving device until a wake up request is received. The step of preventing the transmission of network packets may include the step of performing packet filtering. The step of signaling the power saving device to wake up may include the step of forwarding network packets for the power saving device.

Embodiments of systems of the present invention are provided which include a power saving device, an access point, and a low power proxy. The power saving device may be capable of operating in at least two power modes, including, for example, an offline mode. The access point may include a wake up agent communicably connected to the power saving device and may be capable of communicating with the power saving device when the power saving device is in at least two of the power modes. The low power proxy may be communicably connected to the wake up agent and the power saving device and be capable of communicating with the power saving device when the power saving device is in at least one of the power modes. The power saving device and the access point may communicate using a wireless network environment even when the access point and the low power proxy communicate using a wired network environment.

Embodiments of mobile stations of the present invention are provided which include a controller, a wake up agent selection module, and a wake up agent informing module. The controller may be capable of operating the mobile station in at least two power modes, including, for example, an offline mode. The wake up agent selection module may be communicably coupled to the controller and capable of identifying at least one wake up agent capable of signaling the mobile station to wake up from a power save mode. The wake up agent informing module may be communicably coupled to the controller and capable of providing information related to the wake up agent or agents identified by the wake up agent selection module. A mobile station may also include a network interface coupled to the controller and capable of communicating in a network protocol. The network interface may be capable of communicating in at least one of the Bluetooth (BTH), wireless LAN, WiMAX, and UWB network protocols.

Embodiments of wake up agents of the present invention may include a controller, a wake up capabilities module, and a wake up module. The wake up capabilities module may be communicably coupled to the controller and able to providing wake up functions for the wake up agent. The wake up module may be communicably coupled to the controller and capable of initiating a wake up command. A wake up agent may also include a network interface communicably coupled to the controller and capable of communicating in a network protocol. The network interface may be capable of communicating in at least one of the Bluetooth, wireless LAN, WiMAX, and UWB network protocols. The network interface may be capable of communicating in a wireless network environment.

These characteristics, as well as additional details, of the present invention are further described herein with reference to these and other embodiments.

### BRIEF DESCRIPTION OF THE DRAWING(S)

Having thus described the invention in general terms, reference will now be made to the accompanying drawings, which are not necessarily drawn to scale, and wherein:

FIG. 1 is a block diagram of a network framework that would benefit from embodiments of the present invention;

FIG. 2 is a schematic control flow diagram of the operation of one embodiment of the present invention in accordance with the network framework of FIG. 1;

FIG. 3 is a schematic block diagram of an entity capable of operating as a mobile station, network node, or a Home Agent of an embodiment of the present invention; and

FIG. 4 is a schematic block diagram of a mobile station capable of operating in accordance with dynamic addressing of an embodiment of the present invention.

### DETAILED DESCRIPTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

It will be appreciated from the following that many types of devices, such as devices referenced herein as mobile stations, including, for example, mobile phones, pagers, handheld data terminals and personal data assistants (PDAs), gaming systems, and other electronics, including, for example, televisions, set-top boxes, appliances, personal computers, laptop computers, and other consumer electronic and computer products, may be used with the present invention. Further, while the present invention is described below with reference to Bluetooth and WLAN wireless access and communication protocols, the present invention is applicable to other wired and wireless access and communication protocols, including, for example, WiMAX and UWB wireless protocols. A UPnP™ device refers to a device which is UPnP™ enabled or compatible. A power saving device refers to a device which can use different power and/or communication connection modes of operation to conserve power consumption.

The present invention allows a power saving device to coordinate a relationship with an access point or relationships with access points capable of waking the power saving device from an offline mode. Network entities capable of waking a power saving device from an offline mode are referred to as wake up agents. Wake up agents can operate to wake up devices in various networks, including, for example, Bluetooth, WLAN, WiMAX, and UWB wake up agents for operating in the respective network protocol and WoL wake up agents for operating LAN protocols such as an Ethernet. The present invention proposes to add wake up agents to a distributed network architecture to permit proxy control of a power saving device while providing the ability to wake the power saving device. Wake up agents may be access points, or may be incorporated or associated hardware and/or software components of access points, capable controlling link-layer communications for transmitting beacon messages to signal a power saving device to awaken from an offline power saving mode to instances when the wake up agent receives a wake up message. A wake up agent associates, binds, ties together, or glues, the beacon signal to the wake up message. For example, a wake up agent can use software and/or software-hardware module such as a wake up module to manage the link-layer wake up signaling of a power saving device upon receipt of a wake up message. Wake up agents are also capable of communicating the wake up capabilities of the wake up agent to a power saving device to permit the power saving device to determine if it should select and use a particular network entity as its wake up agent or as one of its wake up agents. For example, a wake up agent can communicate its wake up capabilities through messaging, such as IP-based messaging, using a wake up capabilities module. The messaging may also manifest in different forms, including, but not limited to, infrared (IR), radio frequency identification (RFID), or other link-layer communications. Thus, the power saving device, such as using a wake up agent selection module, can determine and know which access points can wake it up and possibly select one or more of the wake up capable access points as its wake up agent(s).

The present invention further allows the power saving device to communicate the relationship(s) of the power saving device and its wake up agent(s) to a proxy entity or other control point(s), such as a low power proxy which may also function as a control point. For example, before changing into an offline mode, the power saving device, using a wake up agent informing module, can inform a low power proxy which wake up agent(s) to use if the low power proxy, or other control point, needs to communicate with the power saving device, such as to browse or access files on the power saving device. To accomplish such an action by a power saving device, the low power proxy, for example, may send a UPnP™ control action to the power saving device to obtain information about the wake up agent(s) for the power saving device. Similarly, IR or RFID communications may be used to pass wake up agent information from a power saving device directly to a low power proxy, such as from an RFID tag of a power saving device to an RFID reader of a low power proxy.

The present invention also permits proxy entities, such as a low power proxy or similar control point or access point, to use wake up mechanisms to instruct wake-up capable access points to wake a power saving device from an offline mode, such as to wake a UPnP™ device from a deep sleep offline power saving mode in which IP connectivity is not maintained. For example, a low power proxy can send a wake up message to a wake up agent which identifies the power saving device and provides any additional information such as security information to permit the wake up agent to signal the power saving device on the link-layer to awaken from an offline mode. Using a low power proxy with wake up agents permits the low power proxy to wake a power saving device from an offline mode regardless of the link layer protocol used by the power saving device, so long as the link layer protocol is supported by at least one wake up agent available to the low power proxy and power saving device. The low power proxy is, effectively, able to interface with power saving devices with different link layer protocols for waking up the power saving devices from offline modes without knowing and/or having the capabilities of any link layer wake up mechanism.

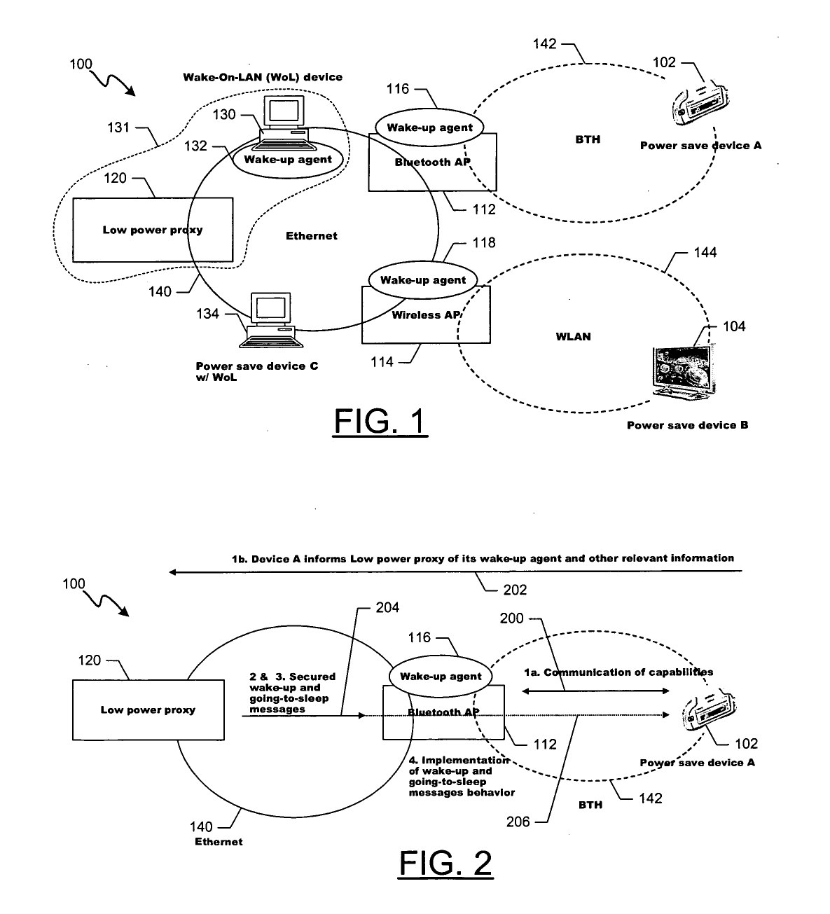

FIG. 1 is an illustration of one type of system that would benefit from the present invention. The network architecture 100 includes an Ethernet 140, a Bluetooth network 142, and a wireless LAN (WLAN) network 144. Such a network architecture might be found, for example, in a digital home environment or a small business or organizational environment. Additional or alternative networks, such as WiMAX and ultra wideband (UWB) networks could also be included in network architectures according to an embodiment of the present invention. At least one device, a power saving device 102, is included in the Bluetooth network 142. A Bluetooth access point 112 is capable of communicating with devices in the Bluetooth network 142. At least one device, a power saving device 104, is included in the wireless LAN network 144. A wireless access point 114 is capable of communicating with devices in the wireless LAN network 144. The Bluetooth access point 112 and the wireless access point 114 may be part of the Ethernet 140. In addition, a low power proxy 120 may be included in a network environment, such as the Ethernet 140. A low power proxy typically is a control point/device combination acting as an agent of a device for handling UPnP™ functions for the device when the device is in a low power setting such as handling UPnP™ control actions. Using low power proxies, other control points can still see the device even when the device may have gone into a sleep mode or offline. For the term “low power proxy,” the adjective “low power” describes the device for which the low power proxy acts as an agent, rather than the proxy itself. “Low power” refers to the modes of operation of a power saving device in which the device hibernates, suspends, sleeps, or discontinues certain services and functions in order to reduce energy consumption, such as UPnP power saving modes described as transparent sleep, deep sleep online, deep sleep offline, and disconnect and like power saving modes. Additional devices typically will also be included in the Ethernet 140, such as a wake-on-LAN (WoL) device 130 and a power saving WoL device 134, such as a computer, television, a set-top box, home audio component, or like consumer electronics. Some or all of these network devices, including the low power proxy, may include a wake up agent capable of signaling other devices to awaken from power saving modes, such as an offline power saving mode, on one or more networks, such as a wake-on-LAN (WoL) wake up agent and a wake-on-Bluetooth wake up agent. For example, the Bluetooth access point 112 may include a wake up agent 116 to permit the Bluetooth access point 112 to signal devices in the Bluetooth network 142 to wake up from power saving modes. The wireless access point 114 may include a wake up agent 118 to permit the wireless access point 114 to signal devices in the wireless LAN network 114 to wake up from a power saving mode. The WoL device 130 in the Ethernet 140 may include a WoL wake up agent 132 to signal devices on the Ethernet 140 to wake up from a power saving mode. Other network devices, including low power proxies, can include WoL wake up agents. For example, the WoL device 130 may include or be incorporated with a low power proxy 120 as a single device 131.

As shown in the network architecture 100 of FIG. 1, a low power proxy 120 does not need to be embodied in an access point or control point to communicate a wake up signal to a power saving device. For example, the low power proxy 120 may communicate through the Ethernet 140 to the wake up agent 116 of the Bluetooth access point 112 to communicate a wake up signal through the Bluetooth network 142 to the power saving device 102. Accordingly, the present invention as shown in FIG. 1 provides for distributed architectures which include a low power proxy to act as an agent for devices in adjacent networks, and in conjunction with wake up agents in the adjacent networks, the lower power proxy is capable of waking the devices in the adjacent networks when the lower power proxy needs to access these devices. In other words, the low power proxy and the wake up agents do not need to be co-located. The low power proxy does not need to know or be capable of link layer wake up mechanisms. Instead, a low power proxy may use discovery and control mechanisms described further below with the use of various wake up agents in the network common to the low power proxy to obtain the same functionality as if the low power proxy included a wake up agent and was capable of link layer wake up mechanisms. By using a distributed architecture as provided for embodiments of the present invention, access points or other wake up agents need not understand UPnP™ or implement UPnP™ low power proxy profiles to support low power features such as waking a device from a deep sleep offline mode. Low power proxies may even be implemented as software modules and need not be equipped with link layer interfaces. In addition, by using a distributed architecture, access points which support new link protocols such as ultra wideband can be added to the network architecture to extend the low power functionality of the system while retaining the control of a low power proxy in the distributed architecture.

FIG. 2 shows an example operation of the present invention in the network architecture of FIG. 1. After the power saving device 102 enters the Bluetooth network 142, such as during configuration of the power saving device 102 in the Bluetooth network 142, during a periodic polling by the power saving device 102 after configuration in the Bluetooth network 142, or as a preliminary step to powering down into an offline mode, the power saving device 102 can communicate with at least one available access point in the Bluetooth network 142, such as the Bluetooth access point 112 in FIG. 2, to identify an available wake up agent which the power saving device 102 can identify as its wake up agent or one of its wake up agents which can be used to wake the power saving device 102 from a power saving offline mode. For example, the power saving device 102 can communicate with the wake up agent 116 of the Bluetooth access point 112 to determine the wake up capabilities of the wake up agent 116 of the Bluetooth access point 112, as shown as communication 1a 200. In such a manner, the power saving device 102 can determine which device or devices can be used to wake up the power saving device 102. If more than one wake up agent is available, a power saving device can choose one of the wake up agents or select more than one of the wake up agents to be used as multiple wake up agents for the power saving device.

After a power saving device decides which wake up agent(s) to use, the power saving device can inform a low power proxy of the identity of the wake up agent(s) which can be used to wake up the power saving device, as shown as communication 1b 202. For example, after the power saving device 102 communicates with the wake up agent 116 of the Bluetooth access point 112 to determine acceptable wake up capabilities of the wake up agent 116, the power saving device 102 can inform the low power proxy 120 about the wake up agent 116 and any other relevant information for the low power wake up mechanisms used in a particular embodiment. For example, the low power proxy 120 can send a UPnP™ control action to the power saving device 102 to obtain information about the wake up agent 116 for the power saving device, such as to obtain the IP address of the wake up agent 116. Using a control action, such as a GetWakeUpInfo message, a low power proxy can obtain such information from the power saving device 102 as the IP address of the power saving device 102, the media access control (MAC) address of the power saving device 102, and any additional wake up mechanism information such as security information. Thus, the standard UPnP™ device description protocol can be modified to permit the use of wake up agents for power saving devices. The power saving device 102 can use any available communication mechanism to communicate with the low power proxy 120, including, for example, IP messaging. As an alternative to changing its UPnP™ device description document, a power saving device can use other mechanisms to communicate the information regarding its wake up agent(s) and other relevant wake up information. For example, a power saving device may use an independent IP messaging scheme or other standard UPnP™ mechanisms such as SSDP optional headers, eventing, and control actions. Thus, the low power proxy 120 learns about a specific wake up agent 116 for the power saving device 102. Once the low power proxy 120 knows the identity of the wake up agent 112 for the power saving device 102, the low power proxy 120 can use this information to wake up the power saving device 102 from an offline mode in which the power saving device 102 would otherwise be unavailable to the low power proxy 120 if not for the wake up agent 116, such as when the power saving device 102 is in a deep sleep offline mode in which IP connectivity is unavailable.

The low power proxy 120 is able to instruct the wake up agent 116 to wake up the power saving device 102 to permit the low power proxy or another control point to communicate with the power saving device 102. For example, the low power proxy 120 can transmit a wake up message or going-to-sleep message to the wake up agent 116. A wake up message or going-to-sleep message may be, for example, an IP based message such as a TCP, UDP, SOAP, UPnP™, or like protocol message. The message communicated from the low power proxy 120 to the wake up agent 116 of the Bluetooth access point 112 includes enough information to permit the wake up agent 116 to communicate an effective wake up function to the power saving device 102, such as by sending a link-layer specific bearer-dependent beacon message from the Bluetooth access point 112 to the power saving device 102. For example, the message from the low power proxy 120 may include the MAC address of the offline power saving device and additional security information such as to identify to the wake up agent 116 that the low power proxy 102 is authorized to wake up the power saving device 102 and to permit the wake up agent 116 to wake up the power saving device 102. Accordingly, the low power proxy 120 is capable of triggering a link layer wake up mechanism in the wake up agent 116 of the Bluetooth access point 112 to wake up the power saving device 102 in an offline mode.

A low power proxy 120 may send a going-to-sleep message, such as a StopForwardPacket message or similar message acknowledging the power mode of the power saving device, to the Bluetooth access point 112 or the wake up agent 116 of the Bluetooth access point 112 to acknowledge the power mode of the power saving device 102, such as to inform the Bluetooth access point 112 to discontinue sending network packets to the power saving device 102, and to permit the wake up agent 116 to understand that the power saving device 102 has entered an offline mode, such as a deep sleep offline mode. This type of going-to-sleep message can trigger a link-specific behavior such as packet filtering for the network traffic which would otherwise be provided to the power saving device 102. Alternatively, if a wake up agent supports UPnP™ sniffing, the wake up agent can learn the power state of a power saving device and independently and automatically initiate packet filtering for the power saving device without receiving a going-to-sleep message.

A wake up message or going-to-sleep message from a low power proxy to a wake up agent can be delivered in a secure manner. For example, a security channel can be established between the low power proxy and the wake up agent before transmitting the wake up message from the low power proxy to the wake up agent, such as by exchanging security keys or making use of a security protocol such as UPnP™ security profile, IP-SEC, SSH, or the like. Alternatively, if one or more of the networks in the relevant network architecture are secure, additional security measures are not necessary in those networks to practice the present invention.

Once received from the low power proxy, a wake up agent should be able to interpret the wake up message and make use of link-layer mechanisms to achieve a desirable wake-up behavior in the power saving device. For example, when the power saving device 102 is in a deep sleep offline mode, the Bluetooth access point 112 should prevent forwarding of network packets, such as filtering. The Bluetooth access point 112 can be informed of the power saving device 102 being in a deep sleep offline mode, for example, when the Bluetooth access point 112 receives a going-to-sleep message for the power saving device 102 or from periodic UPnP sniffing by the Bluetooth access point 112. And when the Bluetooth access point 112, or the wake up agent 116 of the Bluetooth access point 112, receives an SSDP message with a power state header from the power saving device 102 or a power state change notification, such as a StartForwardPacket message or like message indicating the power state change of the power saving device 102, from the low power proxy, the Bluetooth access point 112 should start forwarding network packets to the power saving device 102. An access point may not know when to start forwarding packets to a power saving device if the power saving device wakes up automatically, or otherwise without the assistance of the access point. If the access point is UPnP™ aware, i.e., the access point has UPnP™ sniffing or has UPnP™ Control Point capability, the access point will see the SSDP notifications that contain the power status change from the power saving device and will know that the access point can start forwarding packets to the power saving device. If the access point is not UPnP™ aware, or in case the access point is not UPnP™ aware, the low power proxy may detect the power change status of the power saving device from the SSDP notifications sent by the power saving device. The low power proxy may then send out a message to an access point to let the access point know that the access point can begin forwarding packets to the power saving device, such as the low power proxy sending a StartForwardPacket message to a Bluetooth access point.

In addition to wake up agents being located in access points, wake up agents can also be implemented in routers and other network communication entities which can support wake up capabilities, such as waking UPnP™ devices from a deep sleep offline mode.

Wake up agents can be implemented as add-ons to Network Connectivity Function (NCF) or UPnP IGD device profile. For example, NCF currently proposes to include UPnP™ filtering as an optional feature, therefore providing the opportunity to add a wake up agent on top of the current proposal to achieve, in addition to UPnP™ filtering, low power functions such as distributed architecture wake up capabilities. In the case of UPnP IGD device profile, for example, additional events or control actions can be added to implement the wakeup agents.

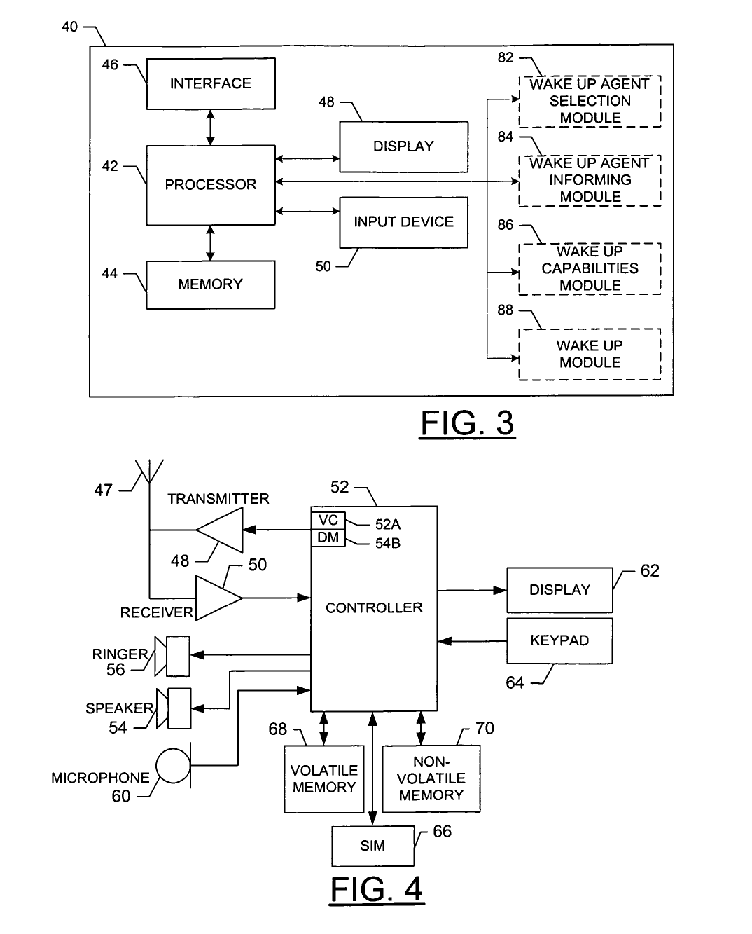

Reference is now made to FIG. 3, which illustrates a block diagram of an entity 40 capable of operating in accordance with a distributed link layer wake up agent system or method for permitting a low power proxy to wake a power saving device from an offline power saving mode using a wake up agent in accordance with at least one embodiment of the present invention. The entity 40 may be, for example, a power saving device, an access point, a control point, a router, a low power proxy, a wake up agent, combinations of these devices such as a low power proxy/control point and an access point/wake up agent, and like network devices operating in accordance with embodiments of the present invention. Although shown as separate entities, in some embodiments, one or more entities may support one or more of the entities, logically separated but co-located within one entity. For example, a single entity may support a logically separate, but co-located, access point and wake up agent. Similarly, some network entities may be embodied as hardware, software, or combinations of hardware and software components.

As shown, the entity 40 capable of operating in accordance with a distributed link layer wake up agent system or method for permitting a low power proxy to wake a power saving device from an offline power saving mode using a wake up agent can generally include a processor, controller, or the like 42 connected to a memory 44. The memory 44 can include volatile and/or non-volatile memory and typically stores content, data, or the like. For example, the memory 44 typically stores computer program code such as software applications or operating systems, instructions, information, data, content, or the like for the processor 42 to perform steps associated with operation of the entity in accordance with embodiments of the present invention. Also, for example, the memory 44 typically stores content transmitted from, or received by, the entity 40. Memory 44 may be, for example, random access memory (RAM), a hard drive, or other fixed data memory or storage device. The processor 42 may receive input from an input device 50 and may display information on a display 48. The processor can also be connected to at least one interface 46 or other means for transmitting and/or receiving data, content, or the like. Where the entity 40 provides wireless communication, such as in a Bluetooth network, a wireless LAN network, or other mobile network, the processor 42 may operate with a wireless communication subsystem of the interface 46. One or more processors, memory, storage devices, and other computer elements may be used in common by a computer system and subsystems, as part of the same platform, or processors may be distributed between a computer system and subsystems, as parts of multiple platforms.

If the entity 40 is, for example, a power saving device, the entity 40 may also include a wake up agent selection module 82 and a wake up agent informing module 84 connected to the processor 42. These modules may be software and/or software-hardware components. For example, a wake up agent selection module 82 may include software capable of managing communications between the power saving device and access points to determine which access points include or can function as wake up agents for the power saving device and to either choose one of the available wake up agents or select which wake up agents will function as the wake up agent for the power saving device. A wake up agent informing module 84 may include software capable of managing communications between the power saving device and a low power proxy, control point, or other network entity to provide information related to the wake up agent(s) identified by the power saving device, such as by a wake up agent selection module 82 of the power saving device, as wake up agents for the power saving device. If the entity 40 is, for example, a wake up agent, the entity 40 may also include a wake up capabilities module 86 and a wake up module 88 connected to the processor 42. These modules may be software and/or software-hardware components. For example, a wake up capabilities module 86 may include software capable of managing communications between the wake up agent and power saving devices to communicate the wake up functionalities, configurations, etc. of the wake up agent. A wake up module 88 may include software capable of managing the communication of a link layer wake up signal to a power saving device in order to awaken the power saving device from an offline power saving mode.

FIG. 4 illustrates a functional diagram of a mobile device, or mobile station (MS) capable of operating as a power saving device in accordance with a distributed link layer wake up agent system or method for permitting a low power proxy to wake the power saving device from an offline power saving mode using a wake up agent of an embodiment of the present invention. It should be understood, that the mobile device illustrated and hereinafter described is merely illustrative of one type of mobile station that would benefit from the present invention and, therefore, should not be taken to limit the scope of the present invention or the type of devices which may operate in accordance with the present invention. While several embodiments of the mobile device are hereinafter described for purposes of example, other types of mobile stations, such as mobile phones, pagers, handheld data terminals and personal data assistants (PDAs), portable gaming systems, laptop computers, and other types of voice and text communications systems, can readily be employed to function with the present invention, in addition to traditionally fixed electronic devices, such as televisions, set-top boxes, appliances, personal computers, laptop computers, and like consumer electronic and computer products. The mobile device shown in FIG. 4 is a more detailed depiction of one version of an entity shown in FIG. 3.

The mobile device includes an antenna 47, a transmitter 48, a receiver 50, and a controller 52 that provides signals to and receives signals from the transmitter 48 and receiver 50, respectively. These signals include signaling information in accordance with the air interface standard of the applicable cellular system and also user speech and/or user generated data. In this regard, the mobile device can be capable of operating with one or more air interface standards, communication protocols, modulation types, and access types. More particularly, the mobile device can be capable of operating in accordance with any of a number of second-generation (2G), 2.5G and/or third-generation (3G) communication protocols or the like. Further, for example, the mobile device can be capable of operating in accordance with any of a number of different wireless networking techniques, including Bluetooth, IEEE 802.11 WLAN (or Wi—Fi®), IEEE 802.16 WiMAX, ultra wideband (UWB), and the like.

It is understood that the controller 52, such as a processor or the like, includes the circuitry required for implementing the video, audio, and logic functions of the mobile device. For example, the controller may be comprised of a digital signal processor device, a microprocessor device, and various analog to digital converters, digital to analog converters, and other support circuits. The control and signal processing functions of the mobile device are allocated between these devices according to their respective capabilities. The controller 52 thus also includes the functionality to convolutionally encode and interleave message and data prior to modulation and transmission. The controller 52 can additionally include an internal voice coder (VC) 52A, and may include an internal data modem (DM) 52B. Further, the controller 52 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile device may also comprise a user interface such as including a conventional earphone or speaker 54, a ringer 56, a microphone 60, a display 62, all of which are coupled to the controller 52. The user input interface, which allows the mobile device to receive data, can comprise any of a number of devices allowing the mobile device to receive data, such as a keypad 64, a touch display (not shown), a microphone 60, or other input device. In embodiments including a keypad, the keypad can include the conventional numeric (0-9) and related keys (#, *), and other keys used for operating the mobile device and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile device can also include memory, such as a subscriber identity module (SIM) 66, a removable user identity module (R-UIM) (not shown), or the like, which typically stores information elements related to a mobile subscriber. In addition to the SIM, the mobile device can include other memory. In this regard, the mobile device can include volatile memory 68, as well as other non-volatile memory 70, which can be embedded and/or may be removable. For example, the other non-volatile memory may be embedded or removable multimedia memory cards (MMCs), Memory Sticks as manufactured by Sony Corporation, EEPROM, flash memory, hard disk, or the like. The memory can store any of a number of pieces or amount of information and data used by the mobile device to implement the functions of the mobile device. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application and may store an update for computer program code for the mobile device.

One of ordinary skill in the art will recognize that the present invention may be incorporated into hardware and software systems and subsystems, combinations of hardware systems and subsystems and software systems and subsystems, and incorporated into network systems and mobile stations thereof. In each of these systems and mobile stations, as well as other systems capable of using a system or performing a method of the present invention as described above, the system and mobile station generally may include a computer system including one or more processors that are capable of operating under software control to provide the techniques described above.

Computer program instructions for software control for embodiments of the present invention may be loaded onto a computer or other programmable apparatus to produce a machine, such that the instructions which execute on the computer or other programmable apparatus create means for implementing the functions described herein. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions described herein. It will also be understood that each element, and combinations of elements, can be implemented by hardware-based computer systems, software computer program instructions, or combinations of hardware and software which perform the specified functions or steps described herein.

The present invention may be specified, for example, in or as an extension to a UPnP™ and/or UPnP™ Low Power Task Force recommendation and/or standard and/or in a future release or extension of the LPnP™ Device Architecture.

Provided herein are systems, methods, and devices for a distributed network architecture for permitting a low power proxy to wake a power saving device from an offline power saving mode using a wake up agent operating a link layer wake up mechanism. The present invention allows a power saving device to coordinate a relationship with an access point or relationships with access points capable of waking the power saving device from an offline mode, allows the power saving device to communicate that(those) relationship(s) to a proxy entity or other control point(s), and to permit these proxy entity(ies) and other control point(s) to use wake up mechanisms to instruct wake-up capable access points to wake a power saving device from an offline mode, such as to wake a UPnP™ device from a deep sleep offline power saving mode.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of communicating with a power saving device, comprising the steps of:
identifying a wake up agent capable of signaling the power saving device to wake up from an offline power mode; and
providing information of an association between the power saving device and the identified wake up agent to a low power proxy.

2. The method of claim 1, wherein said step of identifying a wake up agent comprises the steps of:
establishing communication between the power saving device and the wake up agent; and
communicating the wake up capabilities of the wake up agent to the power saving device.

3. The method of claim 1, further comprising the step of placing the power saving device in an offline power saving mode.

4. A method of communicating with a power saving device, comprising the steps of:
receiving a request to wake up the power saving device; and
signaling the power saving device to wake up in response to the wake up request.

5. The method of claim 4, wherein said step of receiving a request to wake up the power saving device comprises the step of receiving the identity of the power saving device to be awakened.

6. The method of claim 5, wherein said step of receiving a request to wake up the power saving device further comprises the step of receiving security information for waking up the power saving device.

7. The method of claim 4, further comprising the step of associating the wake up request with signaling the power saving device.

8. The method of claim 4, further comprising the step of waking the power saving device from an offline power saving mode.

9. A method of controlling waking up a power saving device, comprising the steps of:
determining offline status of the power saving device;
receiving a wake up message for the power saving device; and
signaling for the power saving device to wake up.

10. The method of claim 9, further comprising the step of preventing the transmission of network packets for the power saving device.

11. The method of claim 9, wherein said step of determining offline status of a power saving device comprises the step of receiving a message acknowledging the power mode of the power saving device.

12. The method of claim 9, wherein said step of determining offline status of a power saving device comprises the step of performing UPnP™ sniffing.

13. The method of claim 9, wherein said step of preventing the transmission of network packets to the power saving device comprises the step of associating the offline status of the power saving device with discontinuing activity which could wake up the power saving device until a wake up request is received.

14. The method of claim 9, wherein said step of preventing the transmission of network packets to the power saving device comprises the step of performing packet filtering for the power saving device.

15. The method of claim 9, wherein said step of signaling for the power saving device to wake up comprises the step of forwarding network packets for the power saving device.

16. The method of claim 9, wherein said step of signaling for the power saving device to wake up comprises the step of sending a link-layer wake up message to the power saving device.

17. A system, comprising:
a power saving device capable of operating in at least two power modes;
an access point comprising a wake up agent communicably connected to said power saving device and capable of communicating with said power saving device when said power saving device is in at least two of said power modes; and
a low power proxy communicably connected to said wake up agent and said power saving device and capable of communicating with said power saving device when said power saving device is in at least one of said power modes.

18. The system of claim 17, wherein at least one of said power modes is an offline mode.

19. The system of claim 17, wherein said power saving device and said access point communicate using a wireless network environment, and wherein said access point and said low power proxy communicate using a wired network environment.

20. The system of claim 17, wherein said power saving device and said access point communicate using a wireless network environment, and wherein said access point and said low power proxy communicate using a wireless network environment.

21. A mobile station, comprising:
a controller capable of operating the mobile station in at least two power modes;
a wake up agent selection module communicably coupled to said controller and capable of identifying at least one wake up agent capable of signaling the mobile station to wake up from a power save mode; and
a wake up agent informing module communicably coupled to said controller and capable of providing information related to the wake up agents identified by said wake up agent selection module.

22. The mobile station of claim 21, wherein one of said power modes in which said controller is capable of operating the mobile station is an offline mode.

23. The mobile station of claim 21, further comprising a network interface communicably coupled to said controller and capable of communicating in a network protocol.

24. The mobile station of claim 23, wherein said network interface is capable of communicating in an IP-capable network protocol.

25. The mobile station of claim 23, wherein said network interface is capable of communicating in at least one of the network protocols selected from the group of: Bluetooth, wireless LAN (WLAN), WiMAX, and ultra wideband (UWB) protocols.

26. The mobile station of claim 21, further comprising an infrared (IR) communications interface communicably coupled to said controller and capable of communicating with the wake up agent informing module for communicating information related to the wake up agents identified by said wake up agent selection module.

27. The mobile station of claim 21, further comprising a radio frequency identification (RFID) communications interface communicably coupled to said controller and capable of communicating with the wake up agent informing module for communicating information related to the wake up agents identified by said wake up agent selection module.

28. A wake up agent, comprising:
a controller;
a network interface communicably coupled to said controller and capable of communicating in a network protocol;
a wake up capabilities module communicably coupled to said controller and capable of providing wake up capabilities of the wake up agent; and
a wake up module communicably coupled to said controller and capable of initiating a wake up command.

29. The wake up agent of claim 28, wherein said network interface is capable of communicating in an IP-capable network protocol.

30. The wake up agent of claim 28, wherein said network interface is capable of communicating in at least one of the network protocols selected from the group of: Bluetooth, wireless LAN (WLAN), WiMAX, and ultra wideband (UWB) protocols.

31. The wake up agent of claim 28, wherein said network interface is capable of communicating in at least one wireless network environment.

32. A low power proxy, comprising:
a controller; and
a network interface communicably coupled to said controller and capable of communicating in a network protocol with a wake up agent for a power saving device; and
a wake up module communicably coupled to said controller and capable of initiating a wake up command to the wake up agent for waking up the power saving device from a power save mode, wherein said network interface is capable of transmitting the wake up command to the wake up agent for the power saving device.

33. The low power proxy of claim 32, further comprising an infrared (IR) communications interface communicably coupled to said controller and capable of receiving wake up information from the power saving device.

34. The low power proxy of claim 32, further comprising a radio frequency identification (RFID) communications interface communicably coupled to said controller and capable of receiving wake up information from the power saving device.
